(19) United States
(12) Patent Application Publication
(10) Pub. No.: US 2016/0073214 A1
(43) Pub. Date: Mar. 10, 2016

(54) VEHICLE ACOUSTIC CONTROL DEVICE, AND VEHICLE ACOUSTIC CONTROL METHOD

(71) Applicant: NISSAN MOTOR CO., LTD., Kanagawa (JP)

(72) Inventors: Yuuki SHIOZAWA, Sagamihara-shi, Kanagawa (JP); Tatsuya SUZUKI, Yokohama-shi, Kanagawa (JP); Kazuma OURA, Atsugi-shi, Kanagawa (JP)

(21) Appl. No.: 14/786,396

(22) PCT Filed: Apr. 23, 2014
(86) PCT No.: PCT/JP2014/002291

§ 371 Date: Oct. 22, 2015

(30) Foreign Application Priority Data
Apr. 24, 2013 (JP) 2013-091683

(51) Int. Cl. H04S 7/00; H04R 5/04

(52) U.S. Cl. CPC H04S 7/30; H04R 5/04; H04S 2400/13

(57) ABSTRACT

A vehicle acoustic control device includes: a plurality of speakers disposed on a periphery of a passenger; and a controller that controls a sound field in a vehicle cabin by individually driving the plurality of speakers. The controller rotates and displaces the sound field in a direction opposite to a changing direction of a vehicle behavior. At this time, when a frequency at a time of change of the vehicle behavior is higher than a predetermined frequency, the controller changes the sound field in the vehicle cabin in the direction opposite to the changing direction of the vehicle behavior, and increases a variation of the sound field as a variation of the vehicle behavior is being larger.

### CROSS REFERENCE TO RELATED APPLICATION

The present application claims priority to Japanese Patent Application No. 2013-091683, filed Apr. 24, 2013, incorporated herein in its entirety.

### TECHNICAL FIELD

The present invention relates to a vehicle acoustic control device, and to a vehicle acoustic control method.

### BACKGROUND

JP 4305333 has focused on the matter that a head portion of a driver moves following a change of a vehicle behavior, and has proposed to keep a desired acoustic effect by estimating a motion of the head portion of the driver from map information and travel state of a vehicle, and by controlling a sound field in a vehicle cabin to follow the motion.

The above-described technology of JP 4305333 attempts matching between such a motion of the driver and a motion of the sound field in the vehicle cabin; however, does not enhance riding comfort of a passenger.

### SUMMARY

It is an object of the present invention to enhance the riding comfort of the passenger.

A vehicle acoustic control device according to an aspect of the present invention is a device, which disposes a plurality of speakers on a periphery of a passenger, and controls a sound field in a vehicle cabin by individually driving the plurality of speakers. Then, the vehicle acoustic control device detects a vertical variation of the vehicle behavior, and changes the sound field in the vehicle cabin in a direction opposite to a changing direction of the vehicle behavior depending on the vertical variation of the vehicle behavior.

In accordance with the present invention, the sound field in the vehicle cabin is changed in the direction opposite to the changing direction of the vehicle behavior, whereby suppression of the vehicle behavior can be rendered. That is to say, even if a change actually occurs in the vehicle behavior, such a feeling (impression) that the vehicle behavior is suppressed can be given to the passenger, and the riding comfort can be enhanced.

### BRIEF DESCRIPTION OF THE DRAWINGS

FIG. 1 is a configuration diagram of a vehicle acoustic control device;

FIG. 2 is a block diagram illustrating an example of acoustic control processing in a first embodiment;

FIG. 3 is an example of a map for use in setting a sound field variation C;

FIG. 4 is an example of the map for use in setting the sound field variation C (dead band, limit);

FIG. 5 is an example of the map for use in setting the sound field variation C (hysteresis);

FIG. 6 is a view schematically illustrating a vehicle cabin space when viewed from above (sound field rotation);

FIG. 7 is a view schematically illustrating the vehicle cabin space when viewed from the above (sound field displacement);

FIG. 8 is a flowchart illustrating an example of the acoustic control processing in the first embodiment;

FIG. 9 is a time chart explaining a sensible behavior of a passenger with respect to an actual vehicle behavior; and

FIG. 10 is a view explaining the sensible behavior of the passenger with respect to the actual vehicle behavior.

### DETAILED DESCRIPTION OF THE EMBODIMENTS

A description is made below of embodiments of the present invention based on the drawings.

### First Embodiment

### [Configuration]

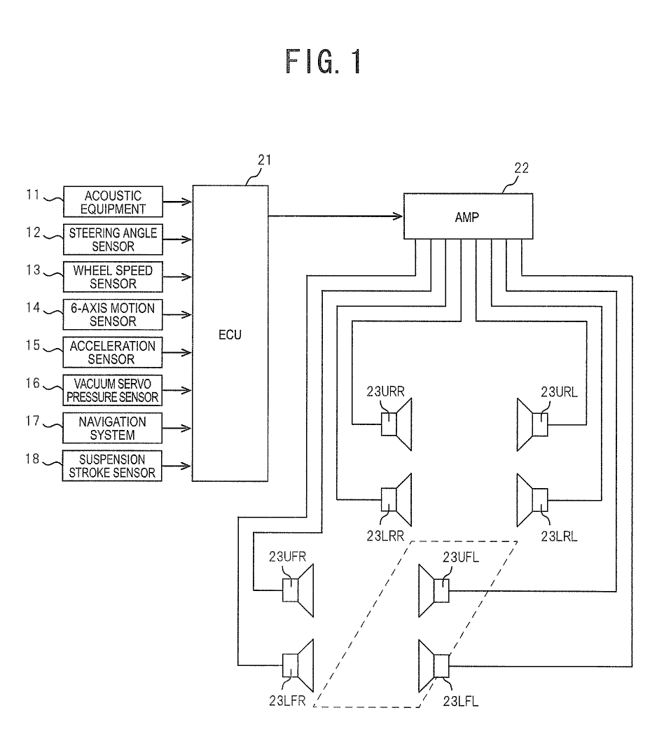

First, a description is made of a configuration of a vehicle acoustic control device. FIG. 1 is a configuration diagram of a vehicle acoustic control device. The vehicle acoustic control device is mounted on an automobile, and includes: acoustic equipment 11; a steering angle sensor 12; a wheel speed sensor 13; a 6-axis motion sensor 14; an accelerator sensor 15; a vacuum servo pressure sensor 16; a navigation system 17; a suspension stroke sensor 18; and a controller 21.

The acoustic equipment 11 outputs a sound signal capable of so-called stereophonic reproduction of reproducing two-channel or more sounds. This acoustic equipment 11 is composed, for example, of a CD drive, a DVD drive, a hard disk drive, a flash memory drive, an AM/FM/TV tuner, a portable audio player or the like. That is to say, by the CD drive, the DVD drive, the hard disk drive, the flash memory drive or the like, sound information is read out from a variety of recording media, and so on, and the sound information is received by a wireless communication made through such an AM/FM/TV tuner or the like, the sound information is inputted from the portable audio player connected through a USB interface or a wireless communication module or the like, and so on. The acoustic equipment 11 outputs the acquired sound signal to the controller 21.

The steering angle sensor 12 is composed of a rotary encoder, and detects a steering angle θs of a steering shaft. When a disc-like scale rotates together with the steering shaft, this steering angle sensor 12 detects light, which transmits through a slit of the scale, by two phototransistors, and outputs a pulse signal, which follows rotation of the steering shaft, to the controller 21. The controller 21 determines the steering angle θs of the steering shaft from the pulse signal inputted thereto. Note that the controller 21 processes clockwise turning as a positive value, and processes counterclockwise turning as a negative value.

The wheel speed sensor 13 detects wheel speeds VwFL to VwRR of the respective wheels. For example, this wheel speed sensor 13 detects magnetic lines of force of a sensor rotor, converts a change of a magnetic field, which follows rotation of the sensor rotor, into a current signal, and outputs the current signal to the controller 21. The controller 21 determines the wheel speeds VwFL to VwRR from the current signal inputted thereto.

In three axes (X-axis, Y-axis, Z-axis) perpendicular to one another, the 6-axis motion sensor 14 detects accelerations (Gx, Gy, Gz) in directions of the respective axes and angular velocities (ωx, ωy, ωz) about the respective axes. Here, a longitudinal direction of a vehicle body is defined as the X-axis, a crosswise direction of the vehicle body is defined as the Y-axis, and a vertical direction of the vehicle body is defined as the Z-axis. In a case of the acceleration, for example, this 6-axis motion sensor 14 detects positional displacements of movable electrodes with respect to fixed electrodes as changes of electrostatic capacitances, converts the changes of the electrostatic capacitances into voltage signals proportional to accelerations in the respective axis directions and to the accelerations and orientations, and outputs the voltage signals to the controller 21. The controller 21 determines the accelerations (Gx, Gy, Gz) from the voltage signals inputted thereto.

Note that the 6-axis motion sensor 14 detects, as positive values, the acceleration in the longitudinal direction, the clockwise turning in the crosswise direction, and a bound in the vertical direction, and detects, as negative values, a deceleration in the longitudinal direction, the counterclockwise turning in the crosswise direction, and a rebound in the vertical direction. Moreover, in a case of the angular velocity, the 6-axis motion sensor 14 vibrates vibrators composed, for example, of crystal tuning forks by an alternating current voltage, converts amounts of distortion of the vibrators, which are generated by the Coriolis force at an input time of the angular velocity, into electrical signals, and outputs the electrical signals to the controller 21. The controller 21 determines such angular velocities (ωx, ωy, ωz) from the electrical signals inputted thereto. Note that the 6-axis motion sensor 14 detects, as positive values, the clockwise turning about a longitudinal axis (roll axis), the acceleration about a crosswise axis (pitch axis), and the clockwise turning about a vertical axis (yaw axis), and detects, as negative values, the counterclockwise turning about the longitudinal axis (roll axis), the deceleration about the crosswise axis (pitch axis), and the counterclockwise turning about the vertical axis (yaw axis).

The accelerator sensor 15 detects a pedal opening degree PPO (operation position) corresponding to a stepping amount of an accelerator pedal. For example, this accelerator sensor 15 is a potentiometer, converts the pedal opening degree PPO of the accelerator pedal into a voltage signal, and outputs the voltage signal to the controller 21. The controller 21 determines the pedal opening degree PPO of the accelerator pedal from the voltage signal inputted thereto. Note that the pedal opening degree PPO becomes 0% when the accelerator pedal is at a non-operation position, and that the pedal opening degree PPO becomes 100% when the accelerator pedal is at a maximum operation position (stroke end).

The vacuum servo pressure sensor 16 detects a pressure in a vacuum servo (brake booster), that is, brake pedal stepping force Pb. This vacuum servo pressure sensor 16 receives the pressure in the vacuum servo by a diaphragm portion, converts distortion, which is generated in a piezoresistance element through this diaphragm portion, as a change of electrical resistance, converts the change of the electrical resistance into a voltage signal proportional to the pressure, and outputs the voltage signal to the controller 21. The controller 21 determines the pressure in the vacuum servo, that is, the brake pedal stepping force Pb from the voltage signal inputted thereto.

The navigation system 17 recognizes a current position of a subject vehicle and road map information at the current position. This navigation system 17 has a GPS receiver, and recognizes the position (latitude, longitude, altitude) and travel direction of the subject vehicle based on time differences between radio waves arriving from four or more GPS satellites. Then, the navigation system 17 refers to road map information including a road type, a road alignment, a lane width, a vehicle passing direction and the like, which are stored in the DVD-ROM drive and the hard disk drive, recognizes the road map information at the current position of the subject vehicle, and outputs the road map information to the controller 21. Note that the navigation system 17 may receive a variety of data from an infrastructure by using DSRC (Dedicated Short Range Communication) as DSSS (Driving Safety Support Systems).

The suspension stroke sensor 18 detects suspension strokes in the respective wheels. For example, this suspension stroke sensor 18 is composed of a potentiometer, converts rotation angles of suspension links into voltage signals, and outputs the voltage signals to the controller 21. Specifically, the suspension stroke sensor 18 outputs a standard voltage at a non-stroke time in a state where the vehicle is in a stationary state, outputs voltages smaller than the standard voltage at a bound-stroke time, and outputs voltage larger than the standard voltage at a rebound-stroke time. The controller 21 determines the suspension strokes in the respective wheels from the voltage signals inputted thereto.

The controller (ECU) 21 is composed, for example, of a microcomputer, executes acoustic control processing based on detection signals from the respective sensors, and drives speakers 23LFL to 23LRR and 23UFL to 23URR through an amplifier (AMP) 22. Note that, in a case where it is not necessary to distinguish the respective speakers, the speakers are described while being denoted by “23” as reference numeral.

The amplifier 22 amplifies the sound signal inputted thereto through the controller 21, then outputs the sound signal to the speakers 23, and moreover, individually adjusts volumes of a treble range, a midrange and a bass range, and adjusts a volume of the stereophonic reproduction for each of channels.

The speakers 23 convert the electrical signal, which is inputted thereto through the amplifier 22, into physical signals, and output the sounds. The respective speakers 23 are provided in a vehicle cabin, and for example, are composed of dynamic speakers. That is to say, the electrical signal is input to a coil connected directly to a diaphragm, and each of the speakers 23 vibrates the diaphragm by vibration of the coil, which is caused by electromagnetic induction, thereby radiating a sound corresponding to the electrical signal. Each of the speakers 23 may be formed as not only a full-range speaker for the entire bandwidth but also a multi-range speaker composed of two-way or more speakers such as a woofer for the bass range, a squawker for the midrange, and a tweeter for the treble range.

Three English letters assigned to the reference numeral of each of the speakers 23 indicate an attachment position thereof in the vehicle cabin: a first letter indicates a vertical position in the vehicle cabin; a second English letter indicates a longitudinal position in the vehicle cabin; and a third English letter indicates a crosswise position in the vehicle cabin. That is to say, “L” as the first English letter indicates a lower side in the vehicle cabin, and “U” as the first English letter indicates an upper side in the vehicle cabin. Moreover, “F” as the second English letter indicates a front side in the vehicle cabin, and “R” as the second English letter indicates a rear side in the vehicle cabin. Furthermore, “L” as the third English letter indicates a left side in the vehicle cabin, and “R” as the third English letter indicates a right side in the vehicle cabin.

Hence, among the respective speakers 23, “LFL” is located on the lower side/front side/left side in the vehicle cabin, “LFR” is located on the lower side/front side/right side in the vehicle cabin, “LRL” is located on the lower side/rear side/left side in the vehicle cabin, and “LRR” is located on the lower side/rear side/right side in the vehicle cabin. Moreover, “UFL” is located on the upper side/front side/left side in the vehicle cabin, “UFR” is located on the upper side/front side/right side in the vehicle cabin, “URL” is located on the upper side/rear side/left side in the vehicle cabin, and “URR” is located on the upper side/rear side/right side in the vehicle cabin. Note that, preferably, the lower side/upper side, the front side/rear side and the left side/right side individually take, as a reference, a listening point of a driver, and specifically, a head portion (ear points) of the driver. The configuration of the vehicle acoustic control device is described as above.

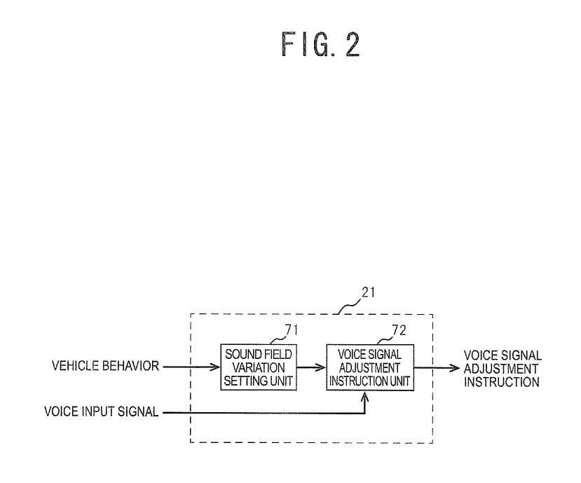

Next, a description is made of the acoustic control processing, which is to be executed by the controller 21, based on a block diagram. FIG. 2 is a block diagram illustrating an example of the acoustic control processing in the first embodiment. In the acoustic control processing, a sound field variation setting unit 71 and a sound signal adjustment instruction unit 72 are provided.

In the sound field variation setting unit 71, a behavior of the vehicle is inputted, and a sound field variation C, by which a sound field in the vehicle cabin is to be changed, is set in a direction opposite to a direction of a change of such a vehicle behavior. The vehicle behavior is an arbitrary vehicle behavior such as those in the longitudinal direction, the transverse direction, the vertical direction (bounce direction), the roll direction, the pitch direction, and the yaw direction, and the same also applies to the sound field variation C. In this embodiment, a description of the sound field variation C is made, for example, on the premise that a component in the yaw direction is a sound field rotation amount α, and that a component in a horizontal direction is a sound field displacement amount β. Moreover, in the sound field displacement amount β, a component in the longitudinal direction is defined as a sound field displacement amount βx, and a component in the transverse direction is defined as a sound field displacement amount βy.

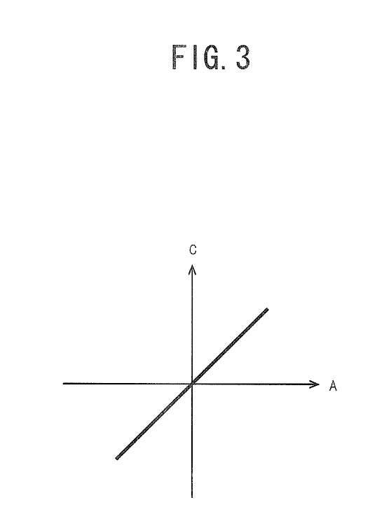

Here, a variation (vibration amplitude) A of the vehicle behavior is calculated, and the sound field variation C is set depending on this variation A. For example, if the vehicle velocity is V, the roll angular velocity is ωx, the pitch angular velocity is ωy, the yaw angular velocity is ωz, and so on, then the variation of the vehicle behavior is calculated as the variation A of each thereof by an integration operation. Moreover, if the longitudinal acceleration is Gx, the transverse acceleration is Gy, the vertical acceleration is Gz, and so on, then the variation of the vehicle behavior is calculated as the variation A of each thereof by two integral operations. Moreover, a roll angle, a pitch angle, a bounce amount and the like may be calculated from a suspension stroke. Moreover, a frequency of each of such parameters of the vehicle behavior is subjected to high-pass filter processing. A cutoff frequency of a high-pass filter is, for example, approximately 0.3 Hz. As a matter of course, band-pass filter processing may be performed in place of the high-pass filter processing. Then, the sound field variation C is set depending on the variation A with reference to maps as illustrated in FIG. 3 to FIG. 5 for example.

FIG. 3 is an example of the map for use in setting the sound field variation C. In accordance with this map, as the variation A is increasing from 0 in a positive direction, the sound field variation C increases from 0 in the positive direction, and as the variation A is decreasing from 0 in a negative direction, the sound field variation C decreases from 0 in the negative direction.

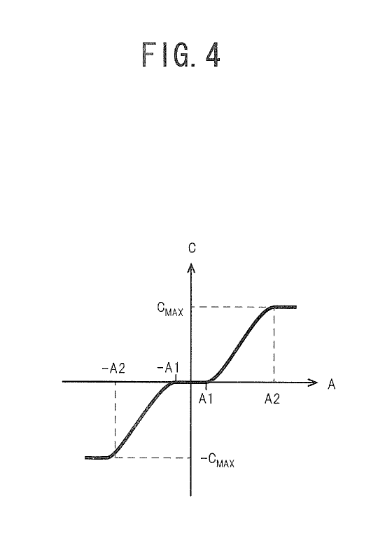

FIG. 4 an example of the map for use in setting the sound field variation C (dead band, limit). Here, with regard to the variation A, A1 and A2, which establish a relationship of 0<|A1|<|A2|, are predetermined, and with regard to the sound field variation C, a maximum variation C_{MAX}, which establishes a relationship of 0<|C_{MAX}|, is predetermined. Note that A1 corresponds to values within ranges which can be regarded as vicinities of 0, and A2 corresponds to values within ranges which can be regarded to be relatively fast in a usual vehicle behavior. Moreover, the maximum variation C_{MAX} is determined depending on the frequency of each of the parameters of the vehicle behavior. Then, when an absolute value of the variation A is within ranges from 0 to |A1|, the sound field variation C is maintained to be 0. Moreover, when the absolute value of the variation A is within ranges from |A1| to |A2|, the sound field variation C is increased within ranges from 0 to the maximum variation C_{MAX} as the variation A is being larger. Furthermore, when the absolute value of the variation A is larger than |A2|, the sound field variation C is maintained to be the maximum variation C_{MAX}.

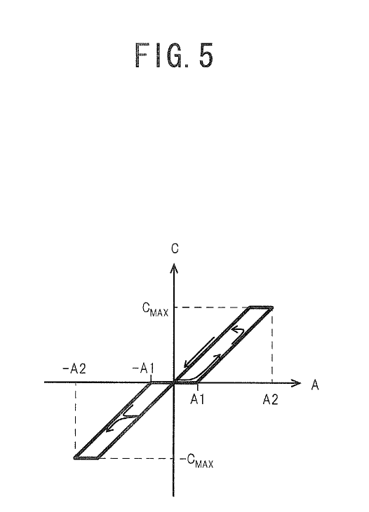

FIG. 5 is an example of the map for use in setting the sound field variation C (hysteresis). This map is one, which is based on the map of FIG. 4 mentioned above, and has a hysteresis provided therein when the absolute value of the variation A turns from the increase to the decrease. That is to say, when the absolute value of the variation A decreases from a state of increasing, such a sound field variation C at a time when the absolute value turns from the increase to the decrease is maintained. Then, when a decrement of the absolute value of the variation A exceeds a predetermined hysteresis amount (for example, A1), the sound field variation C decreases. Moreover, when the absolute value of the variation A turns from the increase to the decrease, and turns to the increase one more time before decreasing to 0, such a sound field variation C at a time when the absolute value turns from the decrease to the increase is maintained. Then, when an increment of the absolute value of the variation A exceeds the predetermined hysteresis amount (for example, A1), the sound field variation C is increased.

Note that, though the sound field variation C is set simply depending on the variation A, the setting of the sound field variation C is not limited to this. For example, when the change of the vehicle behavior is slower than a predetermined speed or is shorter than a predetermined duration time, the sound field variation C may be set at 0. In such a way, unnecessary control for the sound field is suppressed. Moreover, a change speed and a change acceleration may be substituted for the above-described variation A, and the sound field variation C may be set depending on these change speed and change acceleration. The sound field variation C is set as described above.

In order to change the sound field, in which the sounds are outputted by the respective speakers 23, in the direction opposite to that of the change of the vehicle behavior, the sound signal adjustment instruction unit 72 outputs, to the amplifier 22, a driving instruction for adjusting the sound signal.

First, a description is made of rotation of the sound field, in which the sound field where the sounds are outputted by the respective speakers 23 is rotated about a coordinate origin O by a in the direction opposite to that of the change of the vehicle behavior.

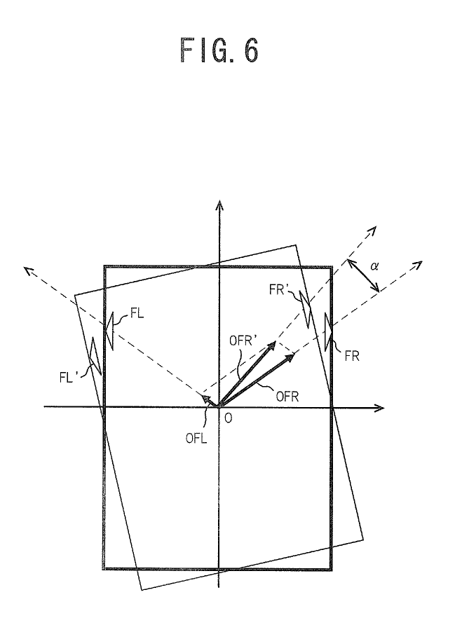

FIG. 6 is a view schematically illustrating the vehicle cabin space when viewed from above (sound field rotation). Here, a description is made of a case where the front left speaker is FL, the front right speaker is FR, and a sound field where the sounds are outputted from these speakers FL and FR is rotated about the coordinate origin O by the angle a in the left direction (counterclockwise). FL′ and FR′ are speaker positions at which the speakers are assumed to be rotated by the angle α. In order that the sound originally heard from the front right speaker position FR can be heard from FR′, a vector OFR′ is first resolved into a vector OFR and a vector OFL. Then, depending on a magnitude ratio of these vector OFR and vector OFL, the sound outputted from the speaker FR is distributed to the speakers FL and FR, followed by synthesis. Also with regard to the other speakers, vectors are resolved in a similar way, and thereafter, are distributed to the other speakers, followed by synthesis. In such a way, the driving instruction for adjusting the sound signal is generated and outputted.

Next, a description is made of displacement (translational movement) of the sound field, in which the sound field where the sounds are outputted by the respective speakers 23 is displaced about the coordinate origin O by β in the direction opposite to that of the change of the vehicle behavior.

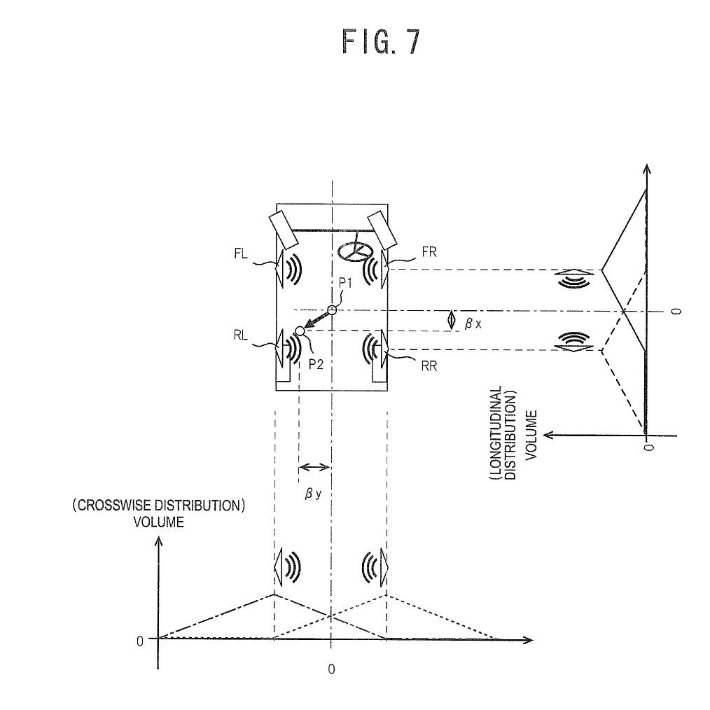

FIG. 7 is a view schematically illustrating the vehicle cabin space when viewed from above (sound field displacement). Here, a description is made of a case where the front left speaker is FL, the front right speaker is FR, the rear left speaker is RL, the rear right speaker is RR, and a center of a sound field where the sounds are outputted from these speakers FL to RR is displaced from a point P1 to a point P2. Here, the point P2 is a position moved from the point P1 to a vehicle body left side by βy along the vehicle width direction, and is a position displaced from the point P1 to a vehicle body rear side by βx along the longitudinal direction.

First, a state where the center of the sound field is located at the point P1 is defined as an initial state. At this time, it is assumed that a volume outputted from the front speakers FL and FR and a volume outputted from the rear speakers RL and RR are equal to each other in a longitudinal distribution, and that a volume outputted from the left speakers FL and RL and a volume outputted from the right speakers FR and RR are equal to each other in a crosswise distribution. In order to displace the center of the sound field from this initial state to the point P2, the longitudinal distribution and crosswise distribution of the volumes are changed.

That is to say, in a case of displacing the center of the sound field to the vehicle body rear side by βx, the volume outputted from the front speakers FL and FR is relatively decreased, and the volume outputted from the rear speakers RL and RR is relatively increased. Here, the volume outputted from the front speakers FL and FR is shown by a solid line, and the volume outputted from the rear speakers RL and RR is shown by a broken line. At this time, a decrement on the front side and an increment on the rear side may be equal to each other or may be different from each other.

Moreover, in a case of displacing the center of the sound field to the vehicle body left side by βy, the volume outputted from the left speakers FL and RL is relatively increased, and the volume outputted from the right speakers FR and RR is relatively decreased. Here, the volume outputted from the left speakers FL and RL is shown by an alternate long and short dashed line, and the volume outputted from the right speakers FR and RR is shown by a dotted line. At this time, an increment on the left side and a decrement on the right side may be equal to each other or may be different from each other. In such a way, the driving instruction for adjusting the sound signal is generated and outputted. The acoustic control processing is described as above based on the block diagram.

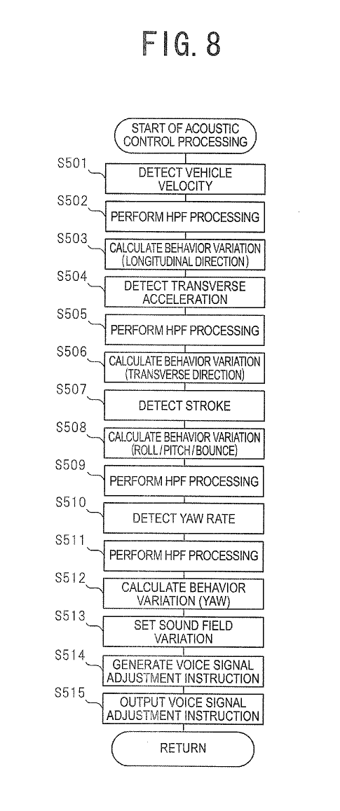

Next, a description is made of the acoustic control processing, which is to be executed by the controller 21, based on a flowchart. FIG. 8 is a flowchart illustrating an example of the acoustic control processing in the first embodiment. First, in Step S501, the vehicle velocity V is detected.

In subsequent Step S502, for example, the frequency of the vehicle velocity V is subjected to the high-pass filter processing. The cutoff frequency of the high-pass filter processing is, for example, approximately 0.3 Hz. In this processing, a stationary component of the vehicle velocity V just needs to be removable, and the changing vehicle behavior just needs to be extractable.

In subsequent Step S503, a variation Ax in the longitudinal direction in the vehicle behavior is calculated by the integration operation of the vehicle velocity V. In subsequent Step S504, the transverse acceleration Gy is detected. In subsequent Step S505, the frequency of the transverse acceleration Gy is subjected to the high-pass filtering. The cutoff frequency of the high-pass filter processing is, for example, approximately 0.3 Hz. In this processing, a stationary component of the transverse acceleration Gy just needs to be removable, and the changing vehicle behavior just needs to be extractable. In subsequent Step S506, a variation Ay in the lateral direction in the vehicle behavior is calculated by two integral operations for the transverse acceleration Gy.

In subsequent Step S507, the suspension strokes in the respective wheels are detected. In subsequent Step S508, the roll angle φx, the pitch angle φy and the bounce Sz are calculated based on the suspension strokes of the respective wheels. In subsequent Step S509, the frequencies of the roll angle φx, the pitch angle φy and the bounce Sz are subjected to the high-pass filtering. The cutoff frequency of the high-pass filter processing is, for example, approximately 0.3 Hz. In this processing, stationary components of the roll angle φx, the pitch angle φy and the bounce Sz just need to be removable, and the changing vehicle behavior just needs to be extractable.

In subsequent Step S510, the yaw rate ωz (hereinafter, denoted by γ) is detected. In subsequent Step S511, the frequency of the yaw rate γ is subjected to the high-pass filter processing. The cutoff frequency of the high-pass filter processing is, for example, approximately 0.3 Hz. In this processing, a stationary component of the yaw rate γ just needs to be removable, and the changing vehicle behavior just needs to be extractable. In subsequent Step S512, a variation Aγ in the yaw direction in the vehicle behavior is calculated by an integral operation for the yaw rate γ.

In subsequent Step S513, the sound field variation C is set depending on the variations A (Ax, Ay, φx, φy, Sz, Aγ) of the vehicle behavior. In subsequent Step S514, in order to change the sound field, in which the sounds are outputted by the respective speakers 23, about the coordinate origin O by C in the direction opposite to that of the change of the vehicle behavior, the driving instruction for adjusting the sound signal is generated. In subsequent Step S515, the driving instruction for adjusting the sound signal is outputted to the amplifier 22, and the acoustic control processing returns to a predetermined main program. The acoustic control processing is described as above based on the flowchart.

### [Functions]

Next, a description is made of functions of the first embodiment. In this embodiment, the plurality of speakers 23 are disposed so as to surround a periphery of a passenger when viewed from above, and two-channel or more sounds are reproduced stereophonically by the plurality of speakers 23. Then, in an event where the vehicle behavior is changed, the sound field in the vehicle cabin is changed in the direction opposite to that of the vehicle behavior. Specifically, a volume distribution of the respective channels is changed, whereby the sound field is rotated, and in addition, a distribution of the volume outputted by one of the speakers arrayed in the changing direction and of the volume outputted by other of the speakers is changed, whereby the center of the sound field is displaced.

That is to say, when the sound field is rotated in the yaw direction (about the Z-axis), the volume distribution of the respective channels is changed by the speakers, which surround the periphery of the passenger when the vehicle body is viewed from above, that is, by the speakers located on the front left, the front right, the rear left and the rear right. Moreover, when the sound field is rotated in the roll direction (about the X-axis), the volume distribution of the respective channels is changed by the speakers, which surround the periphery of the passenger when the vehicle body is viewed from rear, that is, by the speakers located on the upper left, the upper right, the lower left and the lower right. Moreover, when the sound field is rotated in the pitch direction (about the Y-axis), the volume distribution of the respective channels is changed by the speakers, which surround the periphery of the passenger when the vehicle body is viewed from side, that is, by the speakers located on the upper front, the upper rear, the lower front and the lower rear.

Moreover, when the sound field is displaced in the longitudinal direction (X-axis direction), the longitudinal distribution of the volumes is changed by the speakers located in the front and rear of the passenger when the vehicle body is viewed from above, whereby the center of the sound field is displaced. Furthermore, when the sound field is displaced in the transverse direction (Y-axis direction), the crosswise distribution of the volumes is changed by the speakers located in the left and right of the passenger when the vehicle body is viewed from above, whereby the center of the sound field is displaced. Moreover, when the sound field is displaced in the vertical direction (Z-axis direction), the vertical distribution of the volumes is changed by the speakers located above and below the passenger when the vehicle body is viewed from side, whereby the center of the sound field is displaced.

In general, when a tree grows diagonally, a person tends to be given the illusion that the road is inclined, and it is known that a person recognizes an attitude change of his/her own also by a sound. Accordingly, when the sound field in the vehicle cabin is changed in the direction opposite to that of the change of the vehicle behavior, the suppression of the vehicle behavior can be rendered. In such a way, even if the change actually occurs in the vehicle behavior, such a feeling (impression) that the vehicle behavior is suppressed can be given to the passenger. That is to say, the vehicle behavior sensed by the passenger can be suppressed, and accordingly, the riding comfort of the passenger can be enhanced. Note that, as silence of the vehicle cabin space is being higher, such an acoustic effect as described above is conceived to be high, and accordingly, the first embodiment is suitable for a time when a hybrid vehicle runs by a motor (EV mode), an electric vehicle and the like.

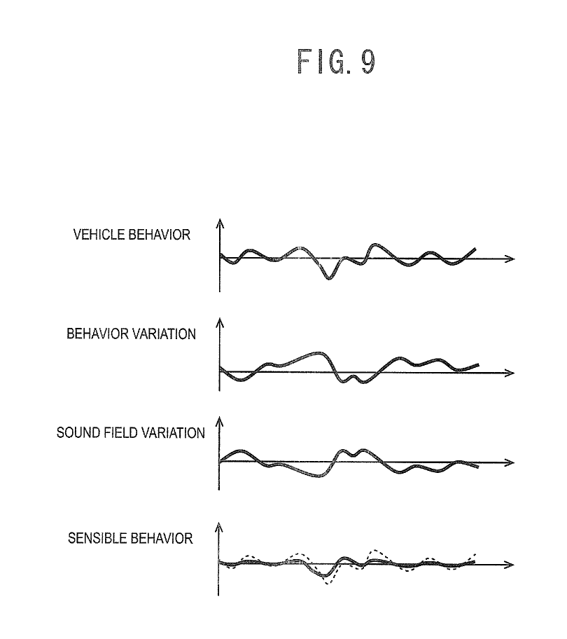

FIG. 9 is a time chart explaining the sensible behavior of the passenger with respect to the actual vehicle behavior. Here, a description is made of a case where an acceleration/deceleration behavior of the vehicle changes. The acceleration/deceleration behavior of the vehicle changes depending on an acceleration/deceleration operation of the driver, such as an acceleration pedal operation and a brake operation. Here, a state is shown, where the high-pass filter processing for the vehicle velocity V is performed, whereby the stationary component is removed, and a vibrational component is extracted. A value, which is obtained by integrating the vibrational component at this time and converting a resultant into a displacement, becomes a behavior variation. Then, the sound field is changed depending on a sound field variation obtained by inverting a sign (positive, negative) of this behavior variation. As described above, the sound field in the vehicle cabin is changed in the direction opposite to that of the vehicle behavior, whereby the sensible behavior (shown by solid line), which is sensed by the passenger, can be suppressed with respect to the actual vehicle behavior (shown by dotted line).

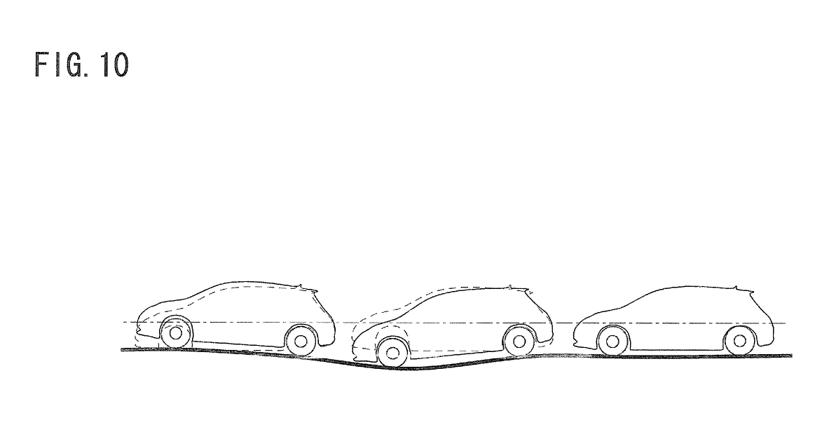

FIG. 10 is a view explaining the sensible behavior of the passenger with respect to the actual vehicle behavior. Here, a description is made of a case where the bounce behavior of the vehicle changes. The bounce behavior of the vehicle changes depending on irregularities and undulations of a road surface. The actual bounce behavior changes in the vertical direction depending on the irregularities and undulations of the road surface; however, the center of the sound field is maintained at a constant height as in a so-called sky-hook control. In such a way, even if the bounce occurs in the actual vehicle behavior (shown by solid line), such a feeling (impression) that the bounce is suppressed can be given to the passenger in the sensible behavior (shown by dotted line) sensed by the passenger.

The sound field variation C is set depending on the behavior variation A, and the sound field variation C is set larger as the behavior variation A is being larger. As described above, the sound field variation C is set larger as the behavior variation A is being larger, whereby the suppression of the vehicle behavior can be rendered effectively.

Moreover, the vibrational component is extracted by removing the stationary component by the high-pass filter processing for the vehicle behavior, whereby the suppression of the vehicle behavior is rendered when the frequency at the time of the change of the vehicle behavior is higher than the predetermined frequency. Hence, if the change of the vehicle behavior is slow, then the sound field is not changed. As described above, only when the change of the vehicle behavior is relatively fast and is inputted as the vibrations, the suppression of the vehicle behavior can be rendered effectively.

Moreover, when the change of the vehicle behavior is smaller than the predetermined variation and is shorter than the predetermined duration time, the sound field variation C may be set at 0. In such a way, such a situation can be suppressed, where the control for the sound field is performed unnecessarily, and a feeling of wrongness is given to the driver.

As described above, the speakers 23LFL to 23LRR and 23UFL to 23URR correspond to the “plurality of speakers”, and the acoustic control processing to be executed by the controller 21 corresponds to the “sound field control unit”. The 6-axis motion sensor 14 corresponds to the “vertical behavior detection unit”.

### [Effects]

Next, a description is made of effects of such main portions in the first embodiment.

(1) The vehicle acoustic control device of this embodiment includes: the plurality of speakers 23 disposed on the periphery of the passenger; and the controller 21 that controls the sound field in the vehicle cabin by individually driving the plurality of speakers 23. The controller 21 changes the sound field in the vehicle cabin in the direction opposite to that of the change of the vehicle behavior. As described above, the suppression of the vehicle behavior can be rendered by changing the sound field in the vehicle cabin in the direction opposite to that of the change of the vehicle behavior. That is to say, even if the change actually occurs in the vehicle behavior, such a feeling (impression) that the vehicle behavior is suppressed can be given to the passenger, and the riding comfort can be enhanced.

(2) In the vehicle acoustic control device of this embodiment, the controller 21 changes the sound field by at least one of the rotation and displacement of the sound field. As described above, the sound field is rotated and displaced, whereby the sound field in the vehicle cabin can be controlled arbitrarily.

(3) In the vehicle acoustic control device of this embodiment, the controller 21 increases the sound field variation C as the behavior variation A is being larger. As described above, the sound field variation C is increased as the behavior variation A is being larger, whereby the suppression of the vehicle behavior can be rendered effectively.

(4) In the vehicle acoustic control device of this embodiment, when the frequency at the time of the change of the vehicle behavior is higher than the predetermined frequency, the sound field in the vehicle cabin is changed in the direction opposite to that of the change of the vehicle behavior. As described above, only when the change of the vehicle behavior is relatively fast and is inputted as the vibrations, the suppression of the vehicle behavior can be rendered effectively.

(5) In the vehicle acoustic control device of this embodiment, when the vehicle behavior changes in the vertical direction, the controller 21 changes the sound field in the vehicle cabin in the direction opposite to that of the change of the vehicle behavior. As described above, the sound field in the vehicle cabin is changed in the direction opposite to that of the bounce when the vehicle bounces, whereby, in the sensible behavior sensed by the passenger, such a feeling that the bounce is suppressed can be given to the passenger in the sensible behavior sensed by passenger even if the bounce occurs.

(6) In the vehicle acoustic control device of this embodiment, the controller 21 drives the plurality of speakers 23 by the sound signal capable of the stereophonic reproduction of reproducing two-channel or more sounds, and changes the volume distribution of the respective channels, thereby rotating the sound field. As described above, the volume distribution of the respective channels is changed to rotate the sound field, whereby the control for the sound field can be performed easily.

(7) In the vehicle acoustic control device of this embodiment, the controller 21, changes the distribution of the volume outputted by one of the speakers arrayed in the displacement direction of the vehicle behavior and of the volume outputted by other of the speakers, thereby displacing the sound field. As described above, the distribution of the volumes is changed to displace the sound field, whereby the control for the sound field can be performed easily.

(8) In the vehicle acoustic control method of this embodiment, the plurality of speakers 23 disposed on the periphery of the passenger are individually driven, whereby the sound field in the vehicle cabin is changed. Then, the sound field in the vehicle cabin is changed in the direction opposite to that of the change of the vehicle behavior, whereby the suppression of the vehicle behavior is rendered. As described above, the suppression of the vehicle behavior can be rendered by changing the sound field in the vehicle cabin in the direction opposite to that of the change of the vehicle behavior. That is to say, even if the change actually occurs in the vehicle behavior, such a feeling (impression) that the vehicle behavior is suppressed can be given to the passenger, and the riding comfort can be enhanced.

Here, the present invention has been described with reference to the definite number of embodiments; however, the scope of the present invention is not limited thereto and improvements and modifications of the embodiments based on the above disclosure are obvious to those skilled in the art.

1. A vehicle acoustic control device comprising:
a plurality of speakers disposed on a periphery of a passenger;
a sound field control unit configured to control a sound field in a vehicle cabin by individually driving the plurality of speakers; and
a vertical behavior detection unit configured detect a vertical variation of a vehicle behavior,
wherein the sound field control unit changes the sound field in the vehicle cabin in a direction opposite to a changing direction of the vehicle behavior depending on the vertical variation of the vehicle behavior detected by the vertical behavior detection unit.

2. The vehicle acoustic control device according to claim 1, wherein the sound field control unit changes the sound field by at least one of rotation and displacement of the sound field.

3. The vehicle acoustic control device according to claim 1, wherein the sound field control unit increases a variation of the sound field as the variation of the vehicle behavior is being larger.

4. The vehicle acoustic control device according to claim 1, wherein, when a frequency at a time of the change of the vehicle behavior is higher than a predetermined frequency, the sound field control unit changes the sound field in the vehicle cabin in the direction opposite to the changing direction of the vehicle behavior.

5. The vehicle acoustic control device according to claim 1, wherein the sound field control unit drives the plurality of speakers by a sound signal capable of stereophonic reproduction of reproducing two-channel or more sounds, changes a volume distribution of respective channels, and changes the sound field.

6. The vehicle acoustic control device according to claim 2, wherein the sound field control unit changes a distribution of a volume outputted from one of the speakers arrayed in the changing direction of the vehicle behavior and a volume outputted from other of the speakers, and changes the sound field.

7. A vehicle acoustic control method of controlling a sound field in a vehicle cabin by individually driving a plurality of speakers disposed on a periphery of a passenger, the vehicle acoustic control method comprising:
detecting a vertical variation of a vehicle behavior; and
changing the sound field in the vehicle cabin in a direction opposite to a changing direction of the vehicle behavior depending on the vertical variation of the vehicle behavior.
